(19) United States
(12) Patent Application Publication
(10) Pub. No.: US 2016/0016771 A1
(43) Pub. Date: Jan. 21, 2016

(54) MODULAR MAN-LIFT APPARATUS

(71) Applicants: Steven Whitaker, Leesburg, FL (US); Shane Elwell, Leesburg, FL (US)

(72) Inventors: Steven Whitaker, Leesburg, FL (US); Shane Elwell, Leesburg, FL (US)

(21) Appl. No.: 14/335,333

(22) Filed: Jul. 18, 2014

(51) Int. Cl. B66F 11/04

(52) U.S. Cl. CPC B66F 11/04

(57) ABSTRACT

A modular man-lift apparatus includes a receiver unit having a trailer attachment along one end, a power winch, and an articulating connector along a distal end. A main shaft assembly is secured to the articulating connector, and a sliding unit having a plurality of opposing wheels is secured to the shaft assembly. A lift basket is secured onto the sliding unit, and a stabilizer unit extends outward from the receiver unit.

### TECHNICAL FIELD

The present invention relates generally to lifting devices, and more particularly to a modular man-lift apparatus which can be deployed from a vehicle mounted trailer hitch.

### BACKGROUND

The statements in this section merely provide background information related to the present disclosure and may not constitute prior art.

Powered lifts are used for a wide variety of commercial and private-use applications. The general concept of the powered lift is to provide a platform that can be raised and lowered, in order to position a user at a desirable height.

One of the most commonly utilized forms of lifting devices employs a wheeled base having a plurality of scissor arms that function to raise and lower a work platform. The wheeled base can be driven or pushed to a particular location wherein the scissor arms are extended so as to raise and lower the platform to a desirable location. In this regard, powered lifts are often used by construction companies in order to lift materials, fixtures and other such items to an elevated location for installation by a worker. Moreover, powered lifts are also commonly utilized in warehouses and factories in order to allow maintenance personnel access to overhead lights and air conditioning units.

Although useful for the above noted industries, traditional lifting devices suffer from many practical drawbacks. For example, the high cost of traditional lifting devices is often too much for small businesses and/or individuals to afford. Moreover, owing to the large size and weight of the conventional lifting device, businesses must find a suitable storage location for the device when not in use, and must also have a specialized trailer and/or heavy equipment to transport the lift to a particular location.

Additionally, the above noted size and cost of the traditional lifting devices make them unsuitable for other industries which would benefit from a lightweight lift. Several such industries include farmers who need a quick and simple lifting device to access elevated trees and the like, pressure washers and painters who are working on second floors of buildings, as well as outdoorsmen such as hunters and bird watchers who could benefit from a low cost portable man lifting device.

Accordingly, it would be beneficial to provide a modular man-lift apparatus that can be easily transported, assembled and secured to the trailer hitch of any vehicle such as a truck, van, tractor and/or ATV, for example, and that does not suffer from the drawbacks of the above noted devices.

### SUMMARY OF THE INVENTION

The present invention is directed to a modular man-lift apparatus. One embodiment of the present invention can include a receiver unit that can be secured onto a vehicle trailer hitch. The receiver unit can include a power winch and an articulating connector along a distal end. A main shaft assembly can be secured to the articulating connector, and a sliding unit having a plurality of opposing wheels can traverse the length of the shaft assembly. A lift basket can be removably secured onto the sliding unit, and a stabilizer unit can be secured to the receiver unit.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of the modular man-lift apparatus that is useful for understanding the inventive concepts disclosed herein.

FIG. 2 is a perspective view of the receiver unit of the modular man-lift apparatus, in accordance with one embodiment of the invention.

FIG. 3 is a perspective view of the main shaft assembly of the modular man-lift apparatus, in accordance with one embodiment of the invention.

FIG. 4 is a perspective view of the sliding unit of the modular man-lift apparatus, in accordance with one embodiment of the invention.

FIG. 5 is a perspective view of the lift basket of the modular man-lift apparatus, in accordance with one embodiment of the invention.

FIG. 6 is a perspective view of the stabilizer unit of the modular man-lift apparatus, in accordance with one embodiment of the invention.

FIG. 7 is a perspective view of the modular man-lift apparatus in operation, and in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

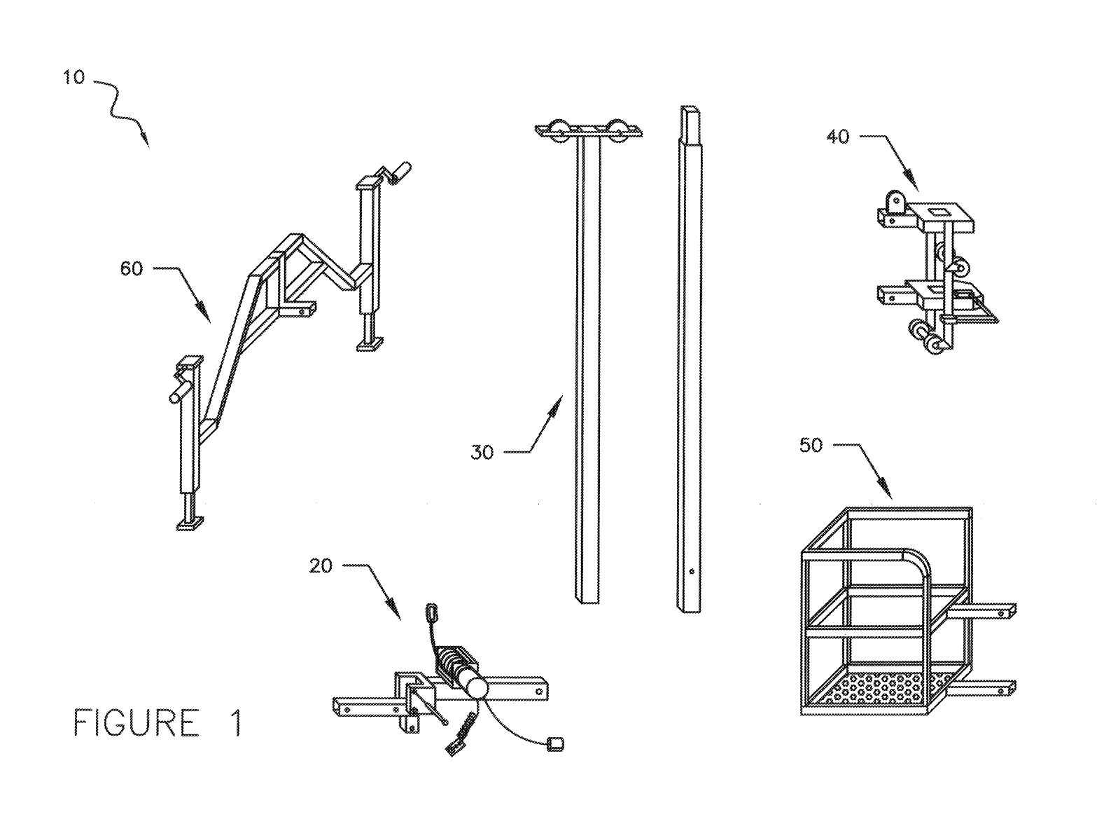

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described herein, the term “removably secured,” and derivatives thereof shall be used to describe a situation wherein two or more objects are joined together in a non-permanent manner so as to allow the same objects to be repeatedly joined and separated. Likewise, the terms “pivotally secured,” “rotatably connected,” and all derivatives shall be used interchangeably to describe a situation wherein two or more objects are joined together in a manner that allows one or both of the objects to pivot and/or rotate about or in relation to the other object. Finally, the terms “slidingly engage,” “slidingly receive,” and derivatives thereof shall be used interchangeably to describe a situation in which two or more components are connected together wherein a portion of one component is slid into a portion of another component.

As described throughout this document, each of the below described “shafts” can preferably be constructed from one or more individual pieces of hollow welded steel square tubing, having any number of different lengths, sizes and other such dimensions. Likewise, each of the below described “connectors” can also be constructed from steel square tubing having a shape, size and dimension that is suitable for slidingly receiving an identified shaft. In some embodiments, a particular shaft and connector can each include one or more openings which are configured to align so as to receive a locking pin (not illustrated) or other such hardware that prevents separation of the components. The construction and operation of each of these features being readily apparent to those of skill in the art, therefore no further description will be provided.

FIG. 1 illustrates one embodiment of a modular man-lift apparatus 10 that is useful for understanding the inventive concepts disclosed herein. As shown, the apparatus 10 can include, essentially, a receiver unit 20, a main shaft assembly 30, a wheeled sliding unit 40, a lift basket 50, and a stabilizer unit 60.

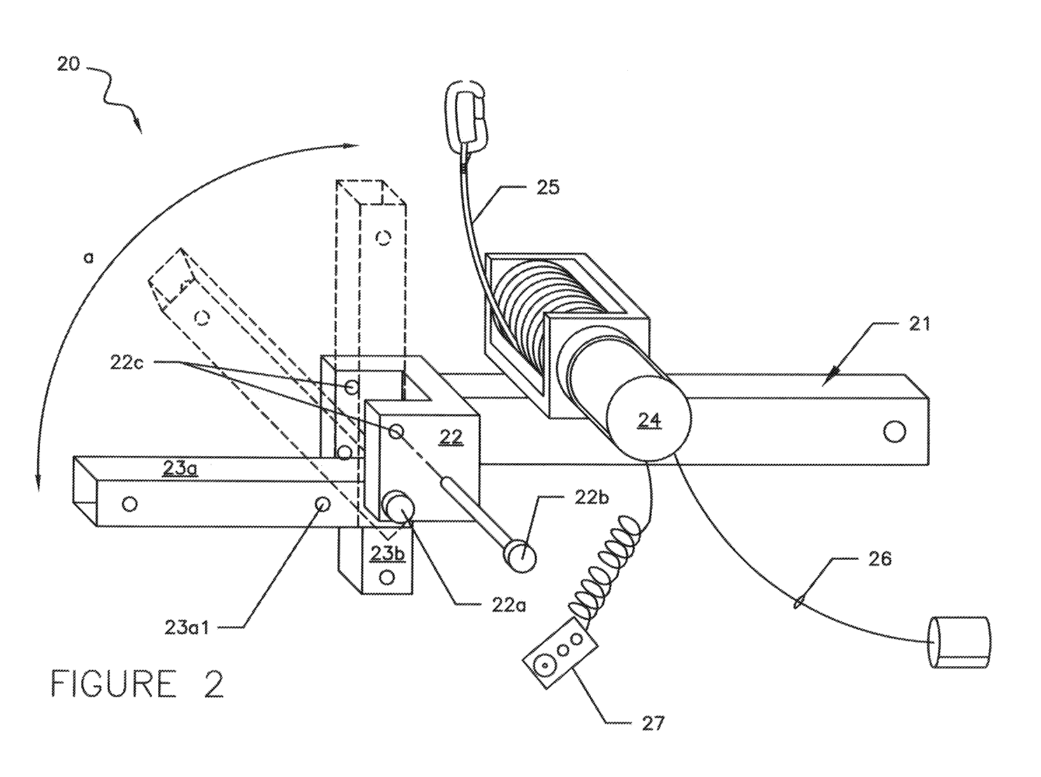

FIG. 2 illustrates one embodiment of the receiver unit 20 that includes an elongated receiver shaft 21 having a first end that functions to slidingly engage a vehicle trailer hitch, and a second end that terminates into a bracket 22. As shown, a generally L-shaped connector 23 is pivotally secured onto the bracket 22 via a rod 22a. The L shaped member including a main shaft connector 23a for engaging the first end 31a of the main shaft assembly, and a stabilizer connector 23b for engaging the stabilizer shaft 63 described below. As shown by arrow a, the L shaped connector can pivot approximately 90 degrees about the rod 22a, and the main shaft connector 23a can be locked into a vertical position via a locking pin 22b which can engage openings 22c and 23a1 in a conventional manner.

A powered winch 24 can be secured onto the receiver shaft 21. In one embodiment, the winch 24 can include a DC powered heavy duty hoist capable of lifting 2000 pounds via a single winch line 25. The winch can further include a trailer power adapter 26, that can be plugged directly into the trailer wiring harness of a vehicle. Operation of the winch can be performed via a controller 27. As will be described below, the controller can ultimately be positioned within the basket 50 in order to allow a user operating the apparatus to remain in control at all times.

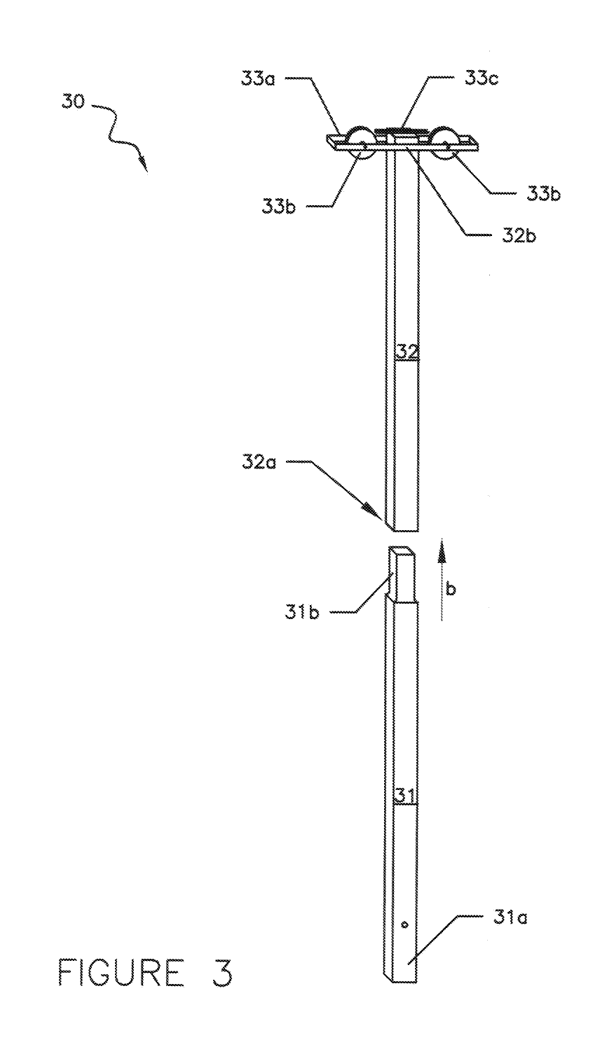

FIG. 3 illustrates one embodiment of the main shaft assembly 30 that includes a lower shaft 31, an upper shaft 32 and a pulley system 33. As shown, the lower shaft can include a first end 31a for slidingly engaging the connector 23a, and a second end having a tapered section 31b. The upper shaft 32 can include a first end 32a that slidingly receives the tapered end 31b of the first shaft (See arrow b), and a second end 32b which terminates into the pulley system 33.

In one embodiment, the pulley system can include a bracket 33a having a generally orthogonal relationship with the upper shaft 32. A pair of independently rotatable pulleys 33b can be located along each end of the bracket, and a guide channel 33c is interposed between the pair of pulleys. As described herein, the pulley system can utilize any number of different and/or additional pulleys which can engage the winch line 25 in any number of different configurations, so as to redirect the tension force experienced by the winch motor in order to gain a mechanical advantage (e.g., 3 to 1). The use, operation and configuration of pulley systems are extremely well known in the art, and need not be repeated here. In addition to the above, the pulley system can also include any number of different locking mechanisms which can be positioned along the guide channel 33c, for example, in order to prevent a winch line from accidentally escaping the channel and/or pulley system.

In the preferred embodiment, each of the shafts 31 and 32 can include a length of approximately 6 feet, and can be constructed from hollow welded steel square tubing. Of course, any number of other lengths and construction materials are also contemplated. Moreover, although described as including two members, other embodiments are contemplated wherein the assembly includes a single shaft, or multiple additional shafts, depending on the height which the apparatus is constructed to reach.

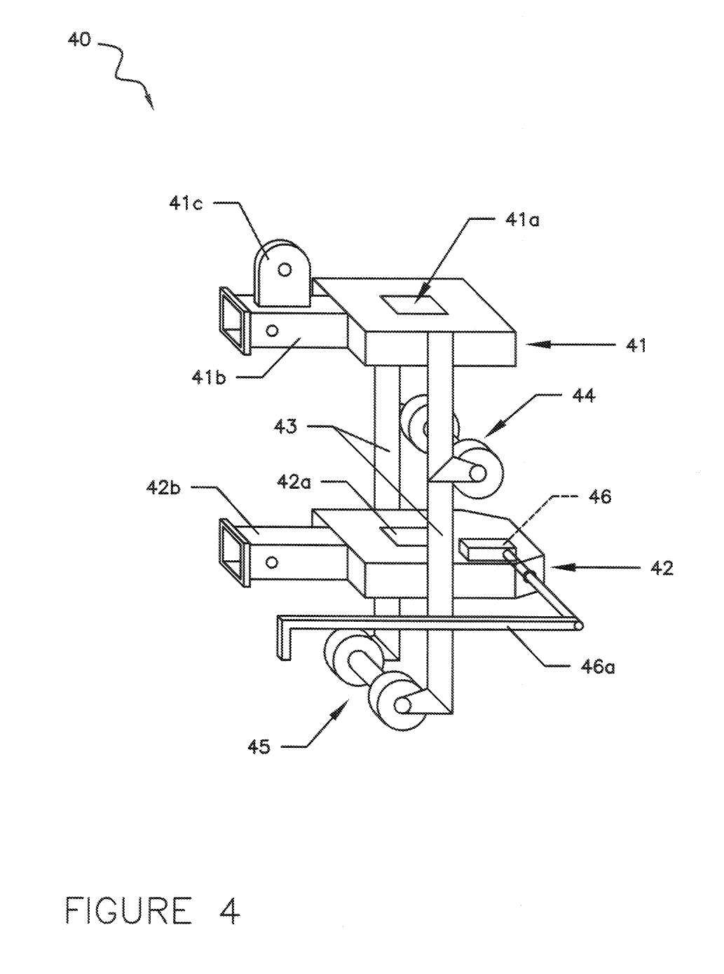

FIG. 4 illustrates one embodiment of the sliding unit 40. As shown, the sliding unit can include an upper collar 41 having a centrally located opening 41a, an upper basket connector 41b and a cable clip 41c. The sliding unit can also include a lower collar 42 having a centrally located opening 42a and a lower basket connector 42b. Each of the collars can be connected by a pair of generally parallel support shafts 43 which function to align the collars and the collar openings in a linear manner.

In the preferred embodiment, each of the collar openings 41a and 42a can include a dimension that is suitable for receiving the main shafts 31 and 32 of the shaft assembly 30. Additionally, each of the upper basket connector 41b and lower basket connector 42b can include dimensions that are suitable for slidingly receiving the basket shafts 51 and 52 described below.

A set of upper rollers 44 can be secured onto one side of each of the support shafts 43 at a location that is adjacent to the bottom end of the upper collar 41, and a set of lower rollers 45 can be secured onto an opposite side of each of the support shafts 43 at a location that is adjacent to the bottom end of the lower collar 42. In this regard, the pair of opposingly positioned rollers 44 and 45 can function to engage the main shaft assembly 30 in order to allow the sliding unit 40 to roll up and down, while preventing the sliding unit from rotating.

In one embodiment, a spring loaded brake 46 is positioned within the lower collar and can be activated by a brake lever 46a. The brake 46 can function to impart a friction force onto the main shaft assembly, thereby locking the sliding unit in place, and preventing movement thereof. Such a feature can be beneficial in an emergency situation wherein failure of the winch and/or winch line occurs, for example.

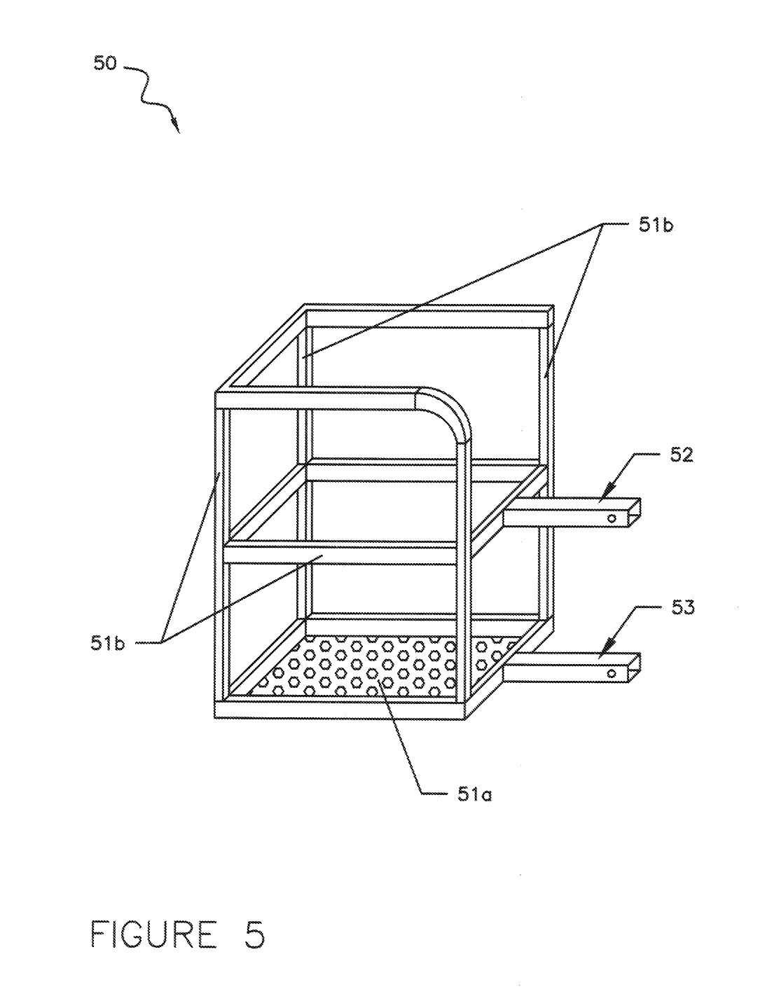

FIG. 5 illustrates one embodiment of the lift basket 50 that includes a generally rectangular basket body that is defined by a steel mesh floor 51a and a plurality of basket walls 51b thereby creating an enclosure for protecting a basket occupant. As shown, the basket can further include an upper connection shaft 52 and a lower connection shaft 53, each having a size, shape, dimension and spacing (relative to each other) that is suitable for slidingly engaging the upper basket connector 41b and the lower basket connector 42b, described above.

Although described above as including a particular shape and construction material, this is for illustrative purposes only, as any number of other basket shapes and construction materials are also contemplated. For example, in another embodiment, the basket can be provided with only a rear wall for supporting the upper connection shaft 52. Such a feature can allow the basket to act as a platform for receiving and lifting large and/or bulky items that would not otherwise fit into the illustrated basket. Additionally, by providing an upper and lower connection shaft, the apparatus provides additional safety to a user, in the unlikely event of a mechanical failure of any one shaft.

Although not illustrated, the basket can be constructed in a modular fashion wherein each of the basket walls can be independently connected to the floor section, in order to allow for easy transport and storage when the apparatus is not in use. Additionally, the basket walls can be hingedly secured together to create a door for allowing an occupant to enter the basket, and finally, the basket can further include a chair which can be permanently or removably mounted to the inside of the basket.

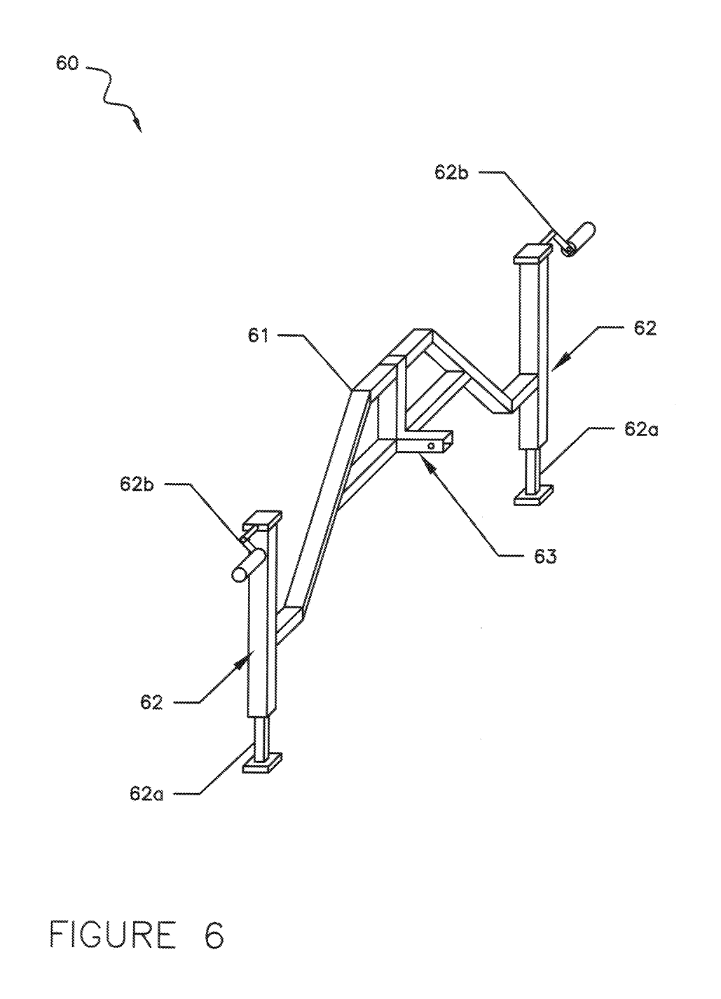

FIG. 6 illustrates one embodiment of the stabilizer unit 60 which can function to prevent the assembly from shifting during use. As shown, the stabilizer unit 60 can include a generally A-shaped frame 61 having a pair of leveling jacks 62 disposed along each side, and a stabilizer shaft 63 extending outward from a middle section. In the preferred embodiment, each of the A-frame member 61 and the stabilizer shaft 63 can be constructed from hollow welded steel square tubing, and the shaft 63 can include dimensions suitable for slidingly engaging the stabilizer connector 23b of the receiver winch unit 20 described above.

As shown, each of the leveling jacks can include telescoping legs 62a which can be operated by a hand crank 62b or power motor (not illustrated). The use and operation of leveling jacks is well known in the art, therefore no further description will be provided.

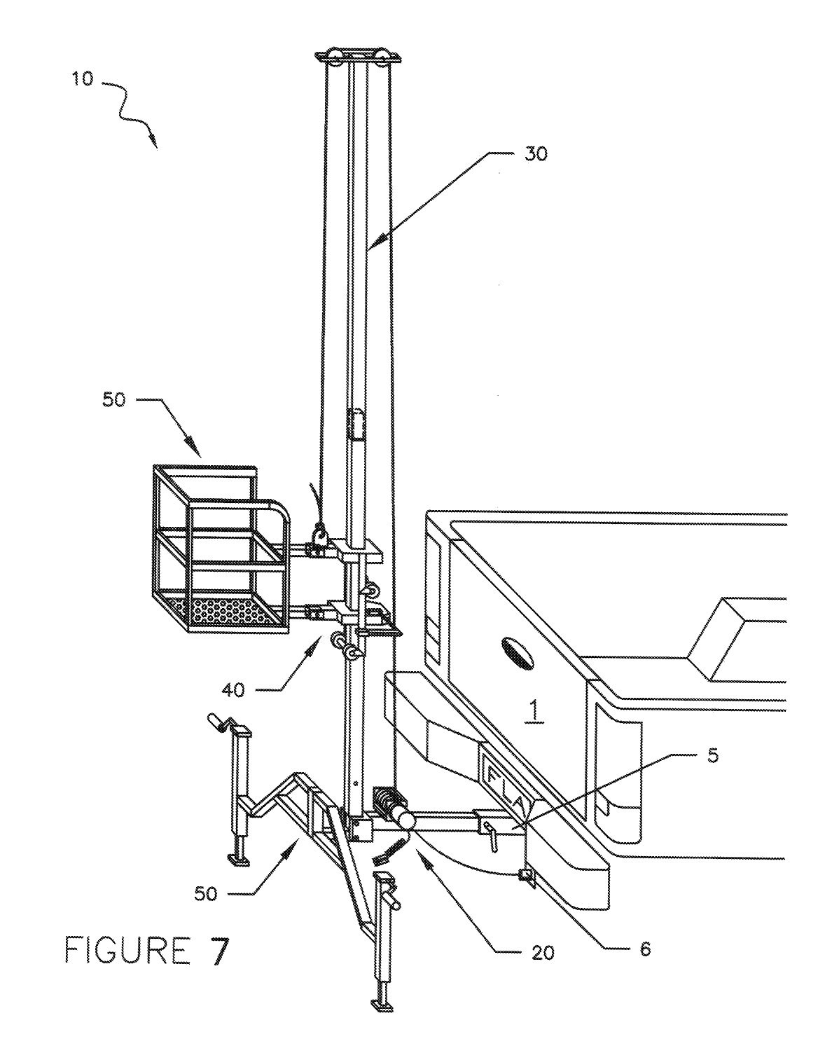

FIG. 7 illustrates one embodiment of the modular man-lift apparatus 10 in an assembled orientation. In operation, the apparatus can be quickly and easily assembled as described below.

First, the receiver shaft 21 of the receiver winch unit 20 can slidingly engage the trailer hitch 5 of a vehicle 1, and the power adapter 26 can be plugged into the trailer wiring harness 6 of the vehicle.

Second, the upper and lower shafts 31 and 32 of the main shaft assembly 30 can be secured together, and the bottom end of the lower shaft 31a can be slid through the collar openings 41a and 42a of the sliding unit 40. When so positioned, the upper and lower rollers 44 and 45 can engage opposite sides of the shaft assembly, in order to allow the sliding unit to move linearly along the shaft assembly in a controlled manner.

Third, the first end of the lower shaft 31a can be secured to the shaft connector 23a of the L-shaped connector 23, the winch line 25 can be connected to the pulley system 33, and the cable clip 41c of the sliding unit. At this time, the shaft connector 23a can be rotated upward (See arrow a) and locked into position wherein the shaft assembly 30 and the sliding unit are standing vertically.

Fourth, the stabilizer unit 60 can be deployed wherein the shaft 63 can engage the stabilizer connector 23b of the receiver winch unit. Owing to the rotation of the L-shaped member, the stabilizer connector 23b will be in a generally horizontal position. Once secured onto the winch unit, each of the leveling jacks 62 can be employed to provide a secure foundation for the assembled unit.

Finally, the upper and lower connection shafts 52 and 53 of the basket 50 can be secured to the upper and lower basket connectors 41b and 42b of the sliding unit 40. Once locked into position, a user can enter the basket and can operate the winch 24 via the winch controller 27, in order to raise and lower the basket 50 along the main shaft assembly.

As described herein, one or more elements of the modular man-lift apparatus 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements of each specified “unit” may be formed together as one or more continuous elements of the unit, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A modular man-lift apparatus, comprising:
a receiver unit that includes
an elongated receiver shaft having a first end that functions to engage a vehicle trailer hitch, and a second end that terminates into a bracket,
a generally L-shaped connector that is pivotally secured to the bracket, said connector including a main shaft connector and a stabilizer connector, and
a power winch that is secured along the receiver shaft, said winch including a winch line and a winch controller;
a main shaft assembly that includes
a lower shaft having a first end and a second end, said first end functioning to engage the main shaft connector of the generally L-shaped connector,
an upper shaft having a first end that functions to slidingly engage the second end of the lower shaft, and a second end that terminates into a pulley system that functions to engage the winch line;
a sliding unit that includes
upper and lower collars that are connected by a pair of support shafts, each of said collars including a centrally located opening that functions to receive the main shaft assembly,
a set of upper rollers that are secured orthogonally along a first side of the support shafts, and a set of lower rollers that are secured orthogonally along an opposite side of the support shafts, said rollers functioning to move the sliding unit along a length of the main shaft assembly;
a stabilizer unit that includes
a generally A-shaped frame member having a pair of telescoping leveling jacks disposed along each end thereof, said unit further including a stabilizer shaft that functions to engage the stabilizer connector of the receiver unit; and
a lift basket that is removably secured to the sliding unit, and configured to move along the shaft assembly.

2. The modular man-lift apparatus of claim 1, wherein the power winch includes a DC powered motor and a trailer power adapter that is configured to engage a vehicle trailer wiring harness.

3. The modular man-lift apparatus of claim 1, wherein the L-shaped bracket is configured to pivot 90 degrees with respect to the receiver bracket.

4. The modular man-lift apparatus of claim 1, wherein the pulley system includes a plurality of independently rotatable pulleys that are each configured to engage the winch line, and a guide channel that functions to prevent separation of the winch line and the plurality of pulleys.

5. The modular man-lift apparatus of claim 1, wherein each of the upper shaft and the lower shaft of the shaft assembly are constructed from hollow welded steel square tubing and include a length of approximately 6 feet each.

6. The modular man-lift apparatus of claim 1, wherein the sliding unit further includes a spring loaded brake that functions to impart a friction force directly onto the shaft assembly when engaged.

7. The modular man-lift apparatus of claim 1, wherein the sliding unit further includes a cable clip that is disposed along the upper collar, said clip being configured to engage the winch line to receive a pulling force.

8. The modular man-lift apparatus of claim 1, wherein the sliding unit further includes an upper basket connector that extends outward from the upper collar in a direction generally opposite to the upper rollers; and
a lower basket connector that extends outward from the lower collar in a direction that is the same as the lower rollers.

9. The modular man-lift apparatus of claim 8, wherein the lift basket further includes an upper connection shaft that functions to engage the upper basket connector of the sliding unit, and a lower connection shaft that functions to engage the lower basket connector of the sliding unit.
